(19) United States
(12) Patent Application Publication
(10) Pub. No.: US 2018/0115387 A1
(43) Pub. Date: Apr. 26, 2018

(54) USER TERMINAL, RADIO BASE STATION AND RADIO COMMUNICATION METHOD

(71) Applicant: NTT DOCOMO, INC., Tokyo (JP)

(72) Inventors: Kazuaki Takeda, Tokyo (JP); Liu Liu, Beijing (CN); Huiling Jiang, Beijing (CN); Qin Mu, Beijing (CN)

(73) Assignee: NTT DOCOMO, INC., Tokyo (JP)

(21) Appl. No.: 15/564,762

(22) PCT Filed: Apr. 8, 2016
(86) PCT No.: PCT/JP2016/061495

§ 371 Date: Oct. 6, 2017

(30) Foreign Application Priority Data
Apr. 9, 2015 (JP) 2015-080322

(51) Int. Cl. H04L 1/00; H04W 72/04

(52) U.S. Cl. CPC H04L 1/0003; H04W 72/042

(57) ABSTRACT

The present invention is designed to reduce the decrease of spectral efficiency even when repetitious transmission is applied to communication by user terminals, in which the bandwidth to use is limited to partial narrow bandwidths in a system bandwidth. According to one aspect of the present invention, a user terminal, in which the bandwidth to use is limited to partial narrow bandwidths in a system bandwidth, has a receiving section that receives downlink control information (DCI), which includes information related to a repetition factor, and a control section that judges the repetition factor to apply to the transmission and/or receipt of a predetermined signal based on the information related to the repetition factor, wherein the information related to the repetition factor is selected in association with the MCS (Modulation and Coding Scheme) that is applied to the predetermined signal.

### TECHNICAL FIELD

The present invention relates to a user terminal, a radio base station and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). Also, successor systems of LTE (also referred to as, for example, “LTE-advanced” (hereinafter referred to as “LTE-A”), “FRA” (Future Radio Access) and so on) are under study for the purpose of achieving further broadbandization and increased speed beyond LTE.

Now, accompanying the cost reduction of communication devices in recent years, active development is in progress in the field of technology related to machine-to-machine communication (M2M) to implement automatic control of network-connected devices and allow these devices to communicate with each other without involving people. In particular, of all M2M, 3GPP (3rd Generation Partnership Project) is promoting standardization with respect to the optimization of MTC (Machine-Type Communication), as a cellular system for machine-to-machine communication (see non-patent literature 2). MTC terminals (MTC UE (User Equipment)) are being studied for use in a wide range of fields, such as, for example, electric meters, gas meters, vending machines, vehicles and other industrial equipment.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall Description; Stage 2”

Non-Patent Literature 2: 3GPP TR 36.888 “Study on provision of low-cost Machine-Type Communications (MTC) User Equipments (UEs) based on LTE (Release 12)”

### SUMMARY OF INVENTION

### Technical Problem

From the perspective of reducing the cost and improving the coverage area in cellular systems, amongst all MTC terminals, low-cost MTC terminals (LC-MTC UEs) that can be implemented in simple hardware structures have been increasing in demand. Low-cost MTC terminals can be implemented by limiting the uplink (UL) bandwidth and the downlink (DL) bandwidth to use to part of a system bandwidth. A system bandwidth is equivalent to, for example, an existing LTE bandwidth (for example, 20 MHz), a component carrier (CC) and so on.

Furthermore, a study is in progress to apply coverage enhancement to MTC terminals. To be more specific, it may be possible to apply, as a method of coverage enhancement, repetitious transmission (repetition), which improves the received-signal-to-interference/noise ratio (SINR: Signal-to-Interference plus Noise Ratio) by repeating transmitting the same signal over multiple subframes in the downlink (DL) and/or the uplink (UL).

However, there is the problem that, if simply repetitious transmission is used, the spectral efficiency, the communication system's capacity (the number of UEs multiplexed) and/or the like may be damaged.

The present invention has been made in view of the above, and it is therefore an object of the present invention to provide a user terminal, a radio base station and a radio communication method that can reduce the decrease of spectral efficiency even when repetitious transmission is applied to communication by user terminals, in which the bandwidth to use is limited to partial narrow bandwidths in a system bandwidth.

### Solution to Problem

According to one aspect of the present invention, a user terminal, in which the bandwidth to use is limited to partial narrow bandwidths in a system bandwidth, has a receiving section that receives downlink control information (DCI), which includes information related to a repetition factor, and a control section that judges the repetition factor to apply to the transmission and/or receipt of a predetermined signal based on the information related to the repetition factor, and the information related to the repetition factor is selected in association with the MCS (Modulation and Coding Scheme) that is applied to the predetermined signal.

### Advantageous Effects of Invention

According to the present invention, it is possible to reduce the decrease of spectral efficiency even when repetitious transmission is applied to communication by user terminals, in which the bandwidth to use is limited to partial narrow bandwidths in a system bandwidth.

### BRIEF DESCRIPTION OF DRAWINGS

FIG. 1 is a diagram to show an example of the arrangement of narrow bandwidths in a system bandwidth;

FIG. 2 is a diagram to show examples of combinations of MCSs and TBSs for use in conventional LTE systems;

FIG. 3 is a schematic diagram of uplink signals to which different repetitions factors are applied depending on MCS when UEs operate in normal coverage;

FIG. 4 is a diagram to show examples of combinations of MCSs and repetition levels when UEs operate in normal coverage;

FIG. 5 show examples of configurations for repetitious transmission when UEs operate in normal coverage;

FIG. 6 is a diagram to show examples of combinations of MCSs and repetition levels when UEs operate in enhanced coverage;

FIG. 7 is a diagram to show examples of subsets of combinations of MCSs and repetition levels;

FIG. 8 is a diagram to show examples of combinations of repetition levels and repetition factors;

FIG. 9 is a diagram to show an example of repetitious transmission control according to a second embodiment;

FIG. 10 is a diagram to show a schematic structure of a radio communication system according to an embodiment of the present invention;

FIG. 11 is a diagram to show an example of an overall structure of a radio base station according to an embodiment of the present invention;

FIG. 12 is a diagram to show an example of a functional structure of a radio base station according to an embodiment of the present invention;

FIG. 13 is a diagram to show an example of an overall structure of a user terminal according to an embodiment of the present invention; and

FIG. 14 is a diagram to show an example of a functional structure of a user terminal according to an embodiment of the present invention.

### DESCRIPTION OF EMBODIMENTS

Studies are in progress to simplify the hardware structures of low-cost MTC terminals at the risk of lowering their processing capabilities. For example, studies are in progress to lower the peak rate, limit the transport block size, limit the resource blocks (also referred to as “RBs,” “PRBs” (Physical Resource Blocks), etc.), and limit the RFs to receive, and so on, in low-cost MTC terminals, in comparison to existing user terminals (LTE terminals).

Low-cost MTC terminals may be referred to simply as “MTC terminals.” Also, existing user terminals may be referred to as “normal UEs,” “non-MTC UEs,” and so on.

Unlike existing user terminals, in which the system bandwidth (for example, 20 MHz, one component carrier, etc.) is configured as the upper limit bandwidth for use, the upper limit bandwidth for use for MTC terminals is limited to a predetermined narrow (reduced) bandwidth (for example, 1.4 MHz). Studies are in progress to operate such bandwidth-limited MTC terminals in LTE/LTE-A system bandwidths, considering the relationship with existing user terminals.

For example, LTE/LTE-A system bandwidths support frequency-multiplexing of bandwidth-limited MTC terminals and bandwidth-unlimited existing user terminals. Consequently, MTC terminals may be seen as terminals in which the maximum bandwidth to support is partial narrow bandwidths in a system bandwidth, or may be seen as terminals which have the functions for transmitting/receiving in narrower bandwidths than LTE/LTE-A system bandwidths.

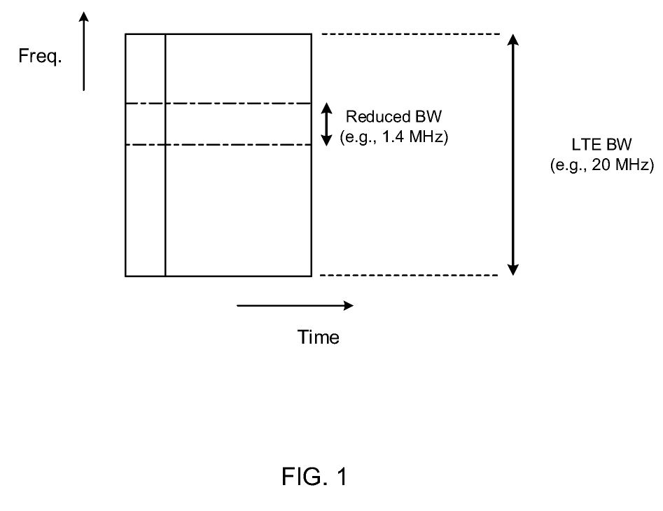

FIG. 1 is a diagram to show an example of the arrangement of narrow bandwidths in a system bandwidth. In FIG. 1, a predetermined narrow bandwidth (for example, 1.4 MHz), which is narrower than an LTE system bandwidth (for example, 20 MHz), is configured in a portion of a system bandwidth. This narrow bandwidth is a frequency bandwidth that can be detected by MTC terminals.

Note that it is preferable to employ a structure, in which the frequency location of a narrow bandwidth, which serves as a bandwidth for use by MTC terminals, can be changed within the system bandwidth. For example, MTC terminals should preferably communicate by using different frequency resources per predetermined period (for example, per subframe). By this means, it is possible to achieve traffic offloading for MTC terminals, achieve a frequency diversity effect, and reduce the decrease of spectral efficiency. Consequently, considering the application to frequency hopping, frequency scheduling and so on, MTC terminals should preferably have an RF re-tuning function.

Now, a study is in progress to apply coverage enhancement to wireless communication by MTC terminals. For example, for MTC terminals, coverage enhancement of maximum 15 dB is under study, in comparison to existing user terminals.

As for the method of coverage enhancement in wireless communication by MTC terminals, the method of repeating transmitting the same signal (transport block) in the uplink (UL) and/or the downlink (DL) may be employed (repetition). However, depending on the environment in which communication takes place, the number of times to repeat transmission (repetition factor) to achieve desired coverage performance (for example, coverage of maximum 15 dB) increases, and therefore the spectral efficiency might decrease.

To be more specific, what repetition factor is required in repetitious transmission is influenced by the channel state and the MCS (Modulation and Coding Scheme) level. UEs in coverage enhancement mode (CE mode) show relatively stable channel states. Meanwhile, an optimal MCS level can change depending on the TBS (Transport Block Size) that is required. This is because the resources to allocate are available only in limited predetermined narrow bandwidths (for example, 1.4 MHz), and, to change the TBS in accordance with the packet size, the MCS level needs to be changed first. As a result of this, to change the MCS, the repetition factor needs to be adjusted in order to maintain the CQI (Channel Quality Indicator)-based received quality in UEs.

Also, both the TBS and the amount of resources to allocate are scheduled dynamically, on a per transmission basis. Consequently, when the number of repetitions is determined taking into consideration the channel state and the MCS, how to configure (report) an adequate repetition factor in a UE, in an adequate timing, based on the MCS, is the problem.

One simple method that may offer a solution to the above problem is to configure a fixed repetition factor in a UE. For example, assuming the maximum TBS (for example, 1000 bits) and the maximum allocation resources (for example, 6 RBs), and based on the UE's channel states, a fixed repetition factor may be determined.

In this case, the eNB and/or the UE transmit/receive data by using a fixed amount of resources and a fixed repetition factor. However, as mentioned earlier, data that is transmitted from an UE and/or others does not always have to be allocated the maximum resources, and an adequate repetition factor might change. Consequently, the above simple method might only lead to poor spectral efficiency and increased power consumption.

So, the present inventors have focused on the point that spectral efficiency and communication overhead are significantly influenced by the configuration of MCSs and repetition factors. Furthermore, the present inventors have focused on the point that downlink control information (DCI) is dynamically reported when resources are allocated to transmit/receive signals.

The present inventors have come up with the idea of selecting information that relates to repetition factors (repetition levels) in association with MCSs, and reporting this information in DCI. One embodiment of the present invention can provide support for a method for flexibly and efficiently configuring repetition factors. By this means, it becomes possible to configure adequate repetitious transmission for uplink/downlink signals, and prevent the decrease of spectral efficiency and the increase of power consumption.

Now, embodiments of the present invention will be described below in detail. Although MTC terminals will be shown as an example of user terminals in which the bandwidth to use is limited to narrow (reduced) bandwidths, the application of the present invention is not limited to MTC terminals. Furthermore, although 6-PRB (1.4-MHz) narrow bandwidths will be described below, the present invention can be applied to other narrow bandwidths as well, based on the present description.

Also, although the following description will primarily show examples to apply repetitious transmission to uplink signals (for example, the PUSCH (Physical Uplink Shared Channel)) that are transmitted from MTC terminals to radio base stations, it is equally possible to apply repetitious transmission to downlink signals (for example, the PDSCH (Physical Downlink Shared Channel)) that are transmitted from radio base stations to MTC terminals. Also, according to the present invention, the signals (channels) to which repetition transmission can be applied are not limited to data signals (the PDSCH, the PUSCH, etc.), and control signals (for example, the EPDCCH (Enhanced Physical Downlink Control Channel)) and reference signals (for example, the CSI-RS (Channel State Information Reference Signal), the CRS (Cell-specific Reference Signal), the DMRS (Demodulation Reference Signal), the SRS (Sounding Reference Signal)) and others are equally applicable.

A “repetition level” herein refers to information that relates to a repetition factor, and may be, for example, a repetition factor itself, or may be predetermined information (for example, an index) that is associated with a repetition factor.

### First Embodiment

According to the first embodiment, the repetition level is implicitly configured (reported). To be more specific, combinations of MCS levels and repetitions levels for use under different channel states are predefined, so that UEs are allowed to know these in advance.

A radio base station can report information related to the combinations of MCS levels and repetition levels to an MTC terminal by using one of broadcast information (the MIB (Master Information Block)), system information (SIBs (System Information Blocks)), higher layer signaling (for example, RRC signaling) and downlink control information, or by combining these. Note that this combination-related information may be designed to be configured in radio base stations and user terminals in advance.

According to the first embodiment, an eNB can determine the repetition level based on a UE's channel states and MCS level. The UE can acquire the repetition level (repetition factor) based on the MCS and/or the channel states reported from the eNB.

According to the first embodiment, the combinations of MCSs and the numbers of repetitions are changed depending on the coverage mode of UEs. To be more specific, the combinations of MCSs and repetition levels are changed between the case where a UE operates in normal coverage (method 1) and the case in which an UE operates in enhanced coverage (method 2).

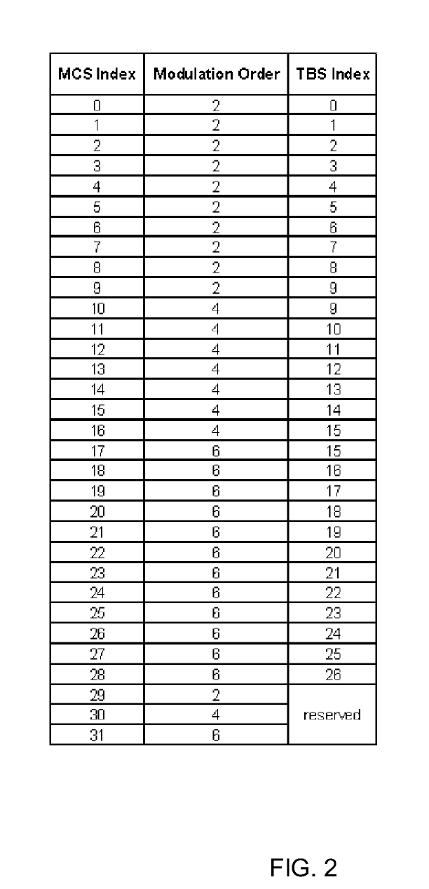

Now, the combinations of MCSs and TBSs for use in conventional LTE systems will be described. FIG. 2 is a diagram to show examples of combinations of MCSs and TBSs for use in conventional LTE systems. FIG. 2 shows a table, in which MCS indices and modulation orders are associated with each other.

An MCS index for a predetermined uplink/downlink signal is reported from a radio base station to a user terminal by means of DCI. A conventional user terminal references the table of FIG. 2, and specifies the modulation order and the TBS index that correspond to the received MCS index. Here, the modulation order is the information for specifying the modulation scheme to apply to the uplink/downlink signal (the number of bits per symbol/subcarrier), where, for example, “2” indicates “QPSK,” “4” indicates “16QAM,” and “6” indicates “64QAM.” Also, the TBS index is the information for specifying the TBS to use for the uplink/downlink signal.

According to the first embodiment, repetition factors are additionally associated with the MCS indices, as shown in FIG. 2.

<Method 1>

When a UE operates in normal coverage, the repetition factor is configured lower when the MCS increases (or when no repetition is made), and the repetition factor is configured higher when the MCS decreases.

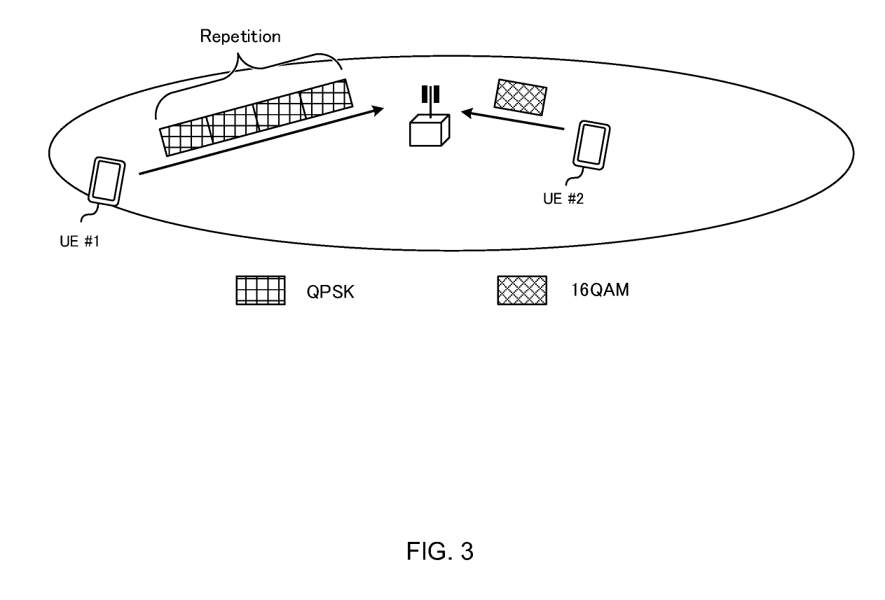

FIG. 3 shows a schematic diagram of uplink signals, where the repetition factor changes in accordance with the MCS, when a UE operates in normal coverage. It is preferable to configure a low MCS in a cell-edge UE (UE #1) to achieve better noise robustness, and, meanwhile, it is preferable to configure a high MCS in a UE near the center of the cell (UE #2) for improved throughput. For example, referring to FIG. 3, method 1 may be designed so that repetitious transmission is not applied (or repetition factor 1 corresponds to) the relatively high MCS of UE #2 (16QAM), and repetition factor 4 corresponds to the relatively high MCS of UE #1 (QPSK).

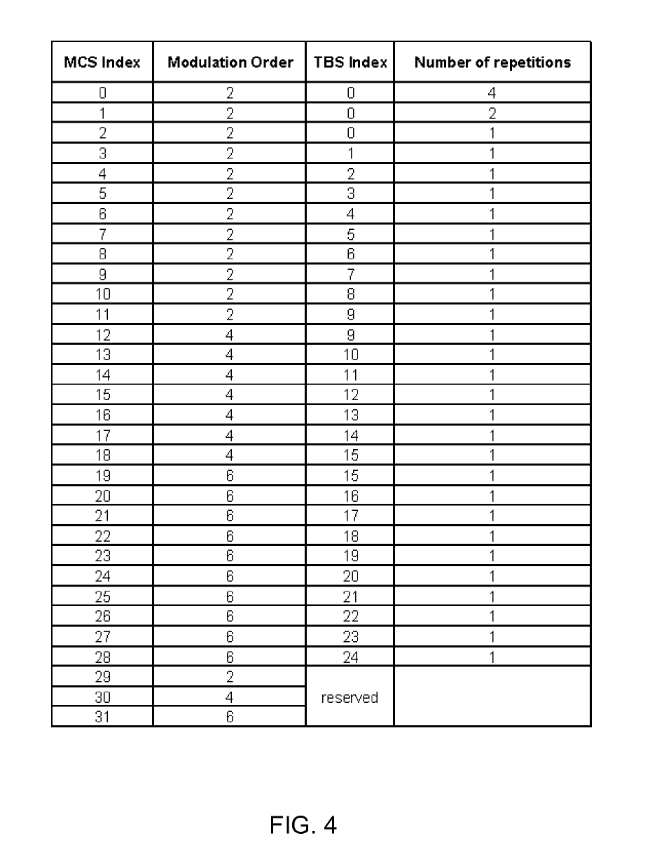

FIG. 4 is a diagram to show examples of the combinations of MCSs and repetition levels when a UE operates in normal coverage. The combinations (table) of FIG. 4 are designed so that, when the MCS index increases, the repetition factor stays the same and/or becomes smaller.

Here, even in normal coverage, it is preferable to provide a certain number of candidates to choose the repetition factor from, even for low MCS levels (and/or low TBS levels). In FIG. 4, repetition factors 4 and 2 are additionally configured for the lowest MCS configuration (modulation order=2 and TBS index=0) in the conventional MCS table shown in FIG. 2. To cope with these additional configurations, it is preferable to make adjustments for keeping only a certain number of items (for example, 32) in the table by, for example, removing part of the higher MCS levels.

Furthermore, although, in FIG. 4, repetition factor 1 (no repetition) is configured except for the lowest TBS, this configuration is by no means limiting. For example, it is possible to associate repetition factor 4 with QPSK (modulation order=2), or associate repetition factor 2 with 16QAM (modulation order=4). Also, MCS levels to correspond to other modulation schemes may be configured. For example, a configuration may be employed in which MCS levels to correspond to 64QAM and 256QAM are set forth, and signals to match these levels are not transmitted in repetitions.

According to the above-described configuration of method 1, it is possible to use reduced repetitious transmission (or make repetitious transmission unnecessary) for UEs that report CSI that is suitable for high MCSs, so that it is possible to adequately reduce the decrease of spectral efficiency.

<Method 2>

When a UE operates in enhanced coverage, by contrast with method 1, the repetition factor is configured lower when the MCS decreases, and the repetition factor is configured higher when the MCS increases. For example, repetition factor 100 corresponds to QPSK, and repetition factor 150 corresponds to 16QAM.

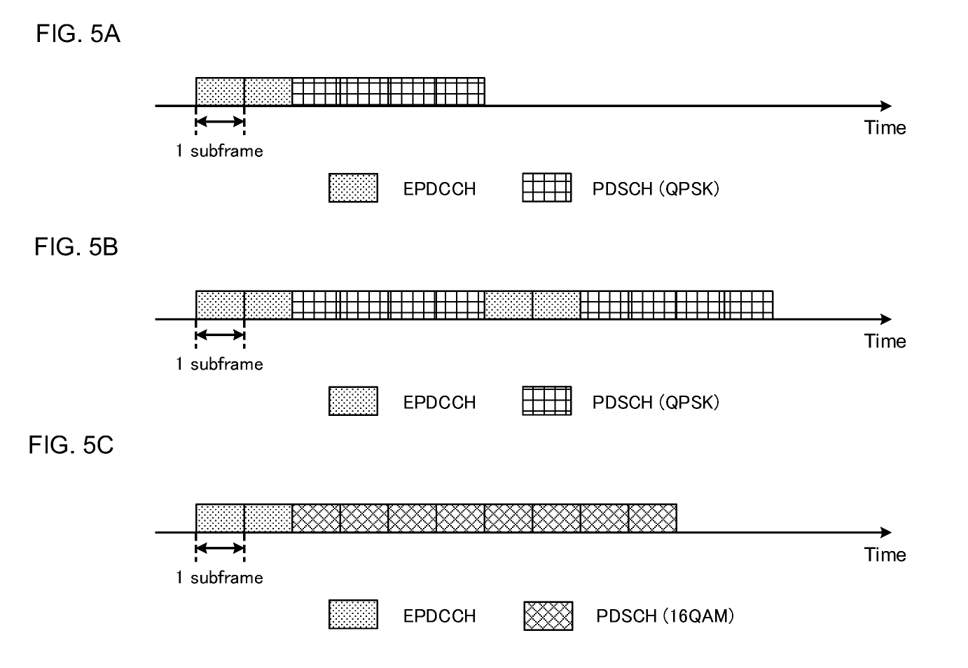

While it is possible to apply the same method as method 1 to enhanced coverage, considering the overhead pertaining to repeated signals, the present inventors have derive the configuration of method 2. This will be described below using FIG. 5. FIG. 5 show examples of configurations for repetitious transmission when UEs operate in normal coverage. Here, when transmission is repeated a predetermined number of times as configured, it may be said, in other words, that one set of repetitious transmission is executed.

FIG. 5A shows an example of the case where the packet size (TBS) is relatively small. For example, assume that the MCS is low and data (PDSCH) is transmitted by using QPSK modulation. In the case of FIG. 5A, 4-time repetitious transmission is configured to match with QPSK. Here, prior to the data transmission, a predetermined control signal (for example, DCI allocated in an EPDCCH) is transmitted in a predetermined subframe in order to specify the resources for repetitious transmission. FIG. 5B shows an example of the case where the packet size (TBS) is relatively large. In this example, again, assume that the MCS is low and data (PDSCH) is transmitted by using QPSK modulation. In the case of FIG. 5B, 4-time repetitious transmission is configured to match with QPSK. However, since the transmission data is large, not only one set of repetitious transmission, but also multiple sets of repetitious t transmission have to be executed. A report is issued in the EPDCCH every time transmission is repeated, and therefore large data results in increased communication overhead.

So, according to method 2, even in an environment in which a low MCS would be selected in conventional systems, a large MCS selected on purpose, and the EPDCCH-induced overhead is reduced. In this case, the repetition factor is also increased, compared to the case where the packet size is relatively small, in order to reduce the decrease of received quality due to the use of the large MCS.

FIG. 5C shows an example of using method 2 when the packet size (TBS) is relatively large. According to the example, a larger MCS (16QAM) and a larger repetition factor (8) than those of FIG. 5B are employed, and the EPDCCH-induced overhead is reduced.

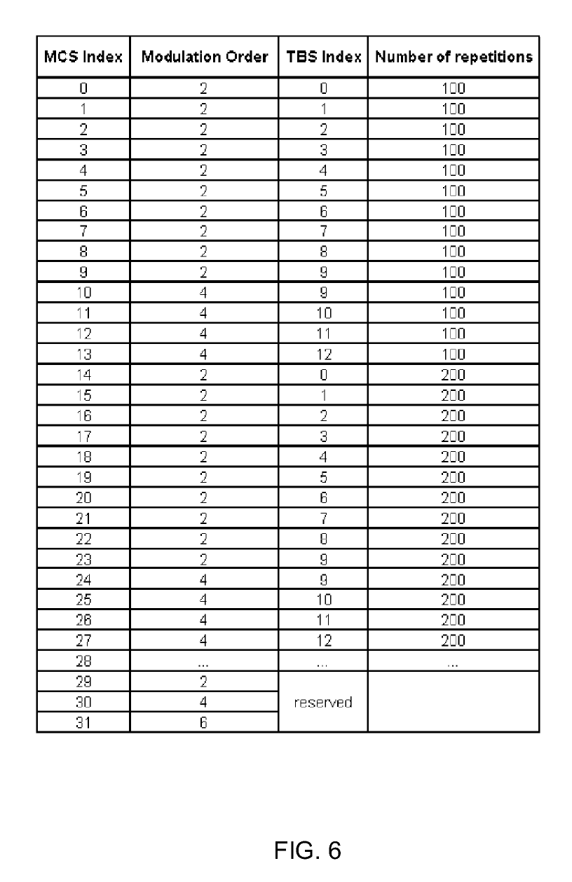

FIG. 6 is a diagram to show an example of the combinations of MCSs and repetition levels when a UE operates in enhanced coverage. The combinations (table) of FIG. 6 are designed so that, when the MCS index increases, the repetition factor stays the same and/or becomes larger.

Note that the combinations of FIG. 6 are simply examples, and are by no means limiting. For example, in addition to (or instead of) designing these combinations so that the repetition factor stays the same and/or becomes larger when the MCS index increases, it is equally possible to design these combinations so that the repetition factor stays the same and/or becomes larger when the TBS index increases.

In enhanced coverage, usually, high MCS levels (and/or high TBS levels) are not used. Consequently, in FIG. 6, items that correspond to relatively high MCS levels are removed from the conventional combinations shown in FIG. 2, and, instead, items of relatively low MCS levels are configured. In this case, a configuration, in which a plurality of repetition factors can be configured for each pair of a modulation order and a TBS index, is employed. In FIG. 6, repetition factors 100 and 200 are configured for MCS indices 0 to 13 in FIG. 2.

Note that it is possible to employ a configuration to include three or more repetition factors, or it is equally possible to employ a configuration in which certain pairs of modulation orders and TBS indices are defined only for part of the repetition factors.

The method of determining combinations such as those shown in FIG. 6 according to method 2 will be described. First, a device on the network end (for example, a radio base station) selects the repetition factor for a signal to transmit and/or receive by using a predetermined modulation scheme (for example, QPSK) (step 1). Here, as the predetermined modulation scheme, it is preferable to use the modulation scheme that has the smallest number of bits per symbol/subcarrier (the one that corresponds to the lowest modulation order) among the modulation schemes from which a selection can be made.

It is preferable to make this selection by taking into consideration the user terminal's coverage. Also, this selection may preferably be made taking into consideration the measurement results (measurement report) of the RSRP (Reference Signal Received Power), the RSRQ (Reference Signal Received Quality), the channel state (CSI: Channel State Information) and so on.

Next, based on the repetition factor of the predetermined modulation scheme selected in step 1, the above device selects candidates (subset) to choose a combination from (step 2). Information related to the selected subset is reported to the user terminal in higher layer signaling (for example, RRC signaling, MAC signaling, broadcast information (for example, SIBs, etc.).

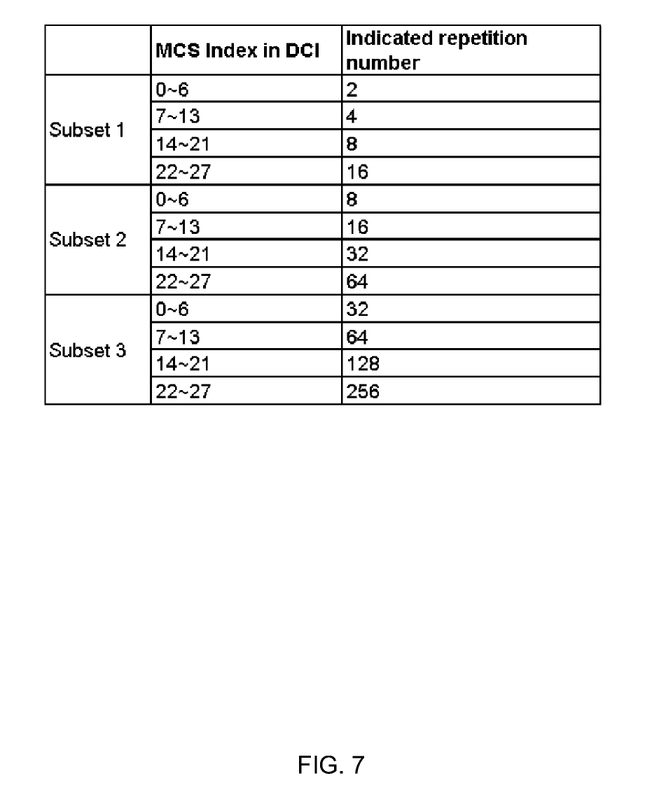

FIG. 7 is a diagram to show examples of combinations of MCSs and repetition levels. In FIG. 7, three subsets are provided, and, in each subset, repetition factors to correspond to MCS indices are stipulated. Note that the number of subsets that can be stipulated is not limited to three. Furthermore, as shown in FIG. 7, these subsets may be designed so that overlapping factors are included in a plurality of subsets.

Note that information related to the subsets of combinations of MCSs and repetition levels may be reported to the UE, in advance, by using broadcast information (for example, SIBs), higher layer signaling (for example, RRC signaling) and so on.

According to the above-described configuration of method 2, it is possible to reduce the increase of EPDCCH overhead by transmitting signals of large TBSs by using high MCSs and large repetition factors, so that it becomes possible to reduce the decrease spectral efficiency adequately.

Note that, according to the first embodiment, the combinations of MCSs and repetition levels may be the same, or may be different, between the uplink (for example, the PUSCH) and the downlink (for example, the PDSCH). When different combinations are used between the uplink and the downlink, the information related to the combinations of MCS levels and repetition levels may be configured to include information for specifying which of the uplink and the downlink the combinations represented pertain to.

Note that, as described above, in a configuration in which repetition levels are associated with MCSs, the corresponding existing combinations of MCSs and CQIs need to be changed as well. Although CQIs are calculated based on received quality (for example, the SINR) as measured by the UE, when coverage enhancement is applied, CQIs to correspond to lower SINRs need to be reported. Consequently, for example, it may be possible to replace part of higher CQIs with new lower CQIs. In an existing CQI table, CQIs are represented by using modulation schemes, coding rates and spectral efficiency. CQIs to correspond to lower SINRs may require repetitious transmission, in addition to lower modulation schemes, and therefore lower coding rates and spectral efficiency need to be added.

Information related to the above CQI table for coverage enhancement may be reported by using broadcast information (for example, SIBs), higher layer signaling (for example, RRC signaling) and so on, or may be configured as pre-defined in the specification. Also, the radio base station and/or the user terminal may employ the CQI table for coverage enhancement only when coverage enhancement mode is identified.

As described above, according to the first embodiment, even when the repetition level is reported dynamically, additional signaling can be made unnecessary, so that it is possible prevent the overhead of communication from increasing, and, meanwhile, reduce the increase of spectral efficiency.

### Second Embodiment

According to a second embodiment, repetition levels are explicitly configured (reported). To be more specific, repetition levels are configured dynamically by using part of the fields in DCI. The repetition levels included in DCI and the actual numbers of repetitions are set forth in combinations, so that UEs are allowed to know these in advance.

A radio base station can report information related to the combinations of repetition levels and repetition factors to MTC terminals by using one of broadcast information, system information, higher layer signaling (for example, RRC signaling) and downlink control information, or by combining these. Note that these combinations may be common in all cells, or may be provided on a per cells basis. Also, the information related to the combinations may be designed to be configured in radio base stations and user terminals in advance.

According to the second embodiment, an eNB can select the repetition level dynamically based on an UE's channel states and the current MCS level (that is, the current TBS and allocation resources). Also, the UE can acquire repetition factors based on the repetition level-related information that is reported.

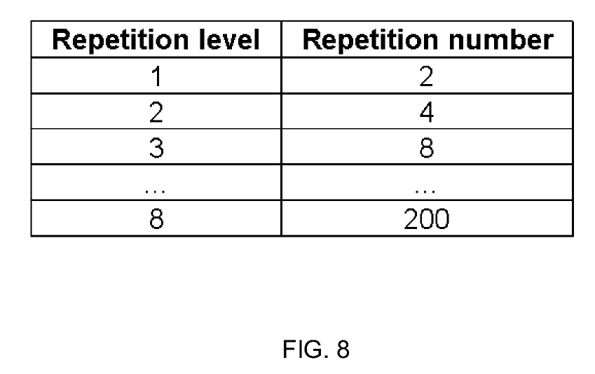

FIG. is a diagram to show examples of combinations of repetition levels and repetition factors. FIG. 8 shows repetition levels and repetition factors (also referred to as “repetition numbers”). For example, a repetition levels can be represented by a bit sequence of 3 bits (000 to 111).

According to the second embodiment, for each transmission and/or receipt, information related to repetition factors is reported by using part or all of a predetermined field in DCI. DCI to include the repetition level should preferably be included in, for example, a UL grant, which specifies the radio resources to use for transmission/receipt, a DL assignment, and so on, but this is by no means limiting.

When the repetition level is placed in DCI, a new bit field that is not stipulated in conventional LTE/LTE-A systems may be introduced, or information may be reported by way of re-interpreting an existing bit field. Existing bit fields such as the resource allocation (RA) field, the MCS (Modulation and Coding Scheme) field, the HPN (HARQ Process Number) field, and so on can be used. Note that other fields can be re-interpreted and used as well.

In MTC terminals, the RA field has only to specify a predetermined narrow bandwidth (for example, 6 RB s) of resources, and therefore the number of bits can be reduced in comparison to the RA fields of existing systems. Consequently, it is possible to use part or all of the RA fields used in existing systems as information related to repetition levels.

Also, when coverage enhancement mode is used in MTC terminals (when signals are transmitted in repetitions), part of the MCSs in existing systems (for example, relatively high MCSs) may not be selected. Consequently, it is possible to use part or all of the MCS fields used in existing systems as information related to repetition levels.

Furthermore, when MTC terminal is used in coverage enhancement mode, the number of HARQ buffers provided in normal terminals that use FDD (Frequency Division Duplex), which is eight (or the number of HARQ buffers provided in normal terminals that use TDD (Time Division Duplex), which is maximum 16) may be reduced. Consequently, it is possible to use part or all of the HPN fields in existing systems as information related to repetition levels. This field is contained in the DL assignment (for example, DCI format 1/1A/1B).

Note that information as to which field in DCI indicates the repetition level may be reported to a user terminal through higher layer signaling (for example, RRC signaling, broadcast information, etc.).

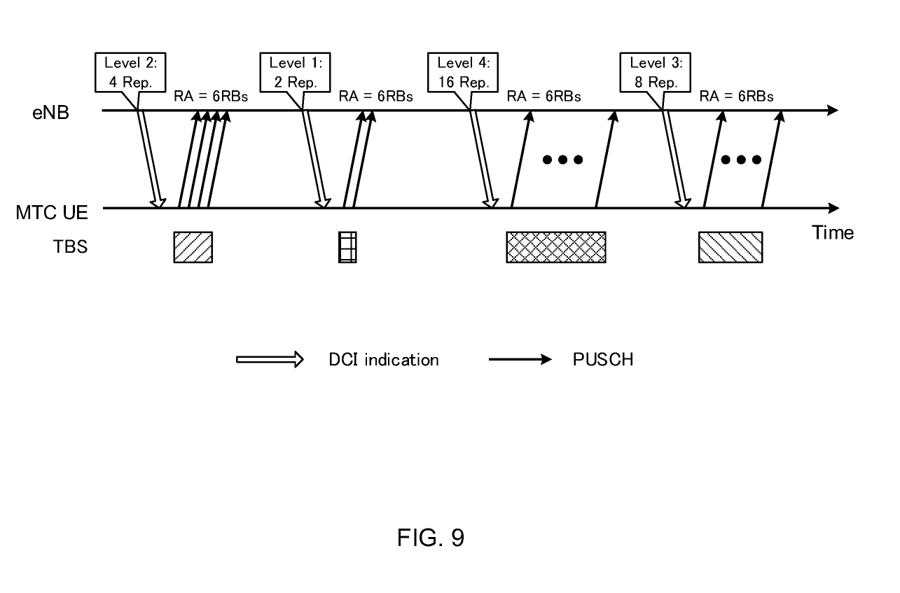

FIG. 9 is a diagram to show an example of repetitious transmission control according to the second embodiment. Assume that, in FIG. 9, the combinations shown in FIG. 8 are already configured in radio base stations (eNBs) and user terminals (MTC UEs). A radio base station can dynamically specify adequate repetition levels by using DCI, based on the volume of transmission resources (TBS) to allocate to user terminals. A user terminal can judge the repetition factors for transmission using the repetition levels included in DCI.

As described above, according to the second embodiment, repetition levels can be implicitly reported to UEs, so that it is possible to reduce the complexity of processing in UEs. Furthermore, it is possible to reduce the increase of communication overhead by reporting repetition levels by using part or all of existing DCI fields.

Note that the combinations of repetition levels and repetition factors shown with the second embodiment may be combined with the first embodiment and used. For example, it is possible to use the combinations of repetition levels and repetition factors that have been described with the second embodiment in order to specify the numbers of repetitions indicated by repetition levels among the combinations of MCSs and repetition levels in the first embodiment.

(Radio Communication System)

Now, the structure of the radio communication system according to an embodiment of the present invention will be described below. In this radio communication system, the radio communication methods according to the above-described embodiments of the present invention are employed. Note that the radio communication methods of the above-described embodiments may be applied individually or may be applied in combination. Here, although MTC terminals will be shown as examples of user terminals in which the bandwidth to use is limited to narrow bandwidths, the present invention is by no means limited to MTC terminals.

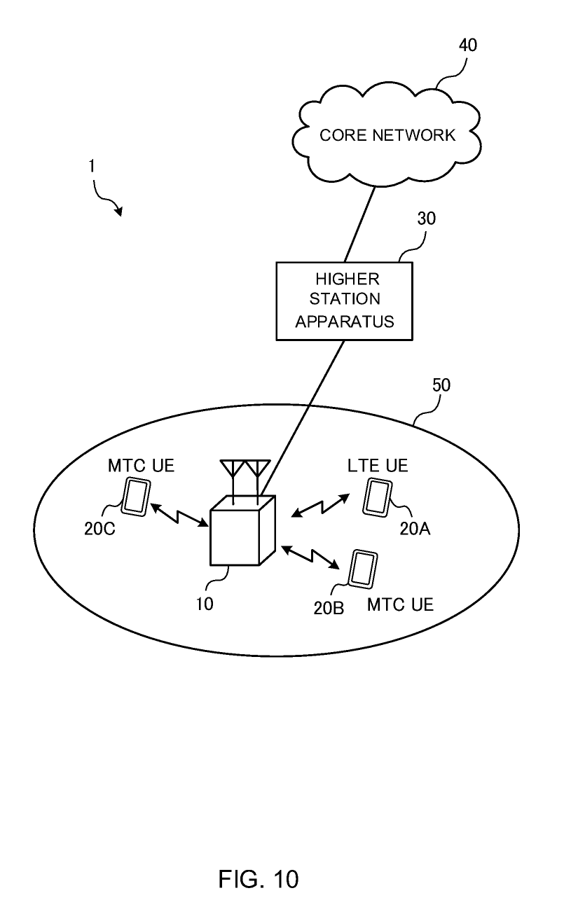

FIG. 10 is a diagram to show a schematic structure of the radio communication system according to an embodiment of the present invention. The radio communication system 1 shown in FIG. 10 is an example of employing an LTE system in the network domain of a machine communication system. The radio communication system 1 can adopt carrier aggregation (CA) and/or dual connectivity (DC) to group a plurality of fundamental frequency blocks (component carriers) into one, where the LTE system bandwidth constitutes one unit. Also, although, in this LTE system, the system bandwidth is configured to maximum 20 MHz in both the downlink and the uplink, this configuration is by no means limiting. Note that the radio communication system 1 may be referred to as “SUPER 3G,” “LTE-A” (LTE-Advanced), “IMT-Advanced,” “4G,” “5G,” “FRA” (Future Radio Access) and so on.

The radio communication system 1 is comprised of a radio base station 10 and a plurality of user terminals 20A, 20B and 20C that are connected with the radio base station 10. The radio base station 10 is connected with a higher station apparatus 30, and connected with a core network 40 via the higher station apparatus 30. Note that the higher station apparatus 30 may be, for example, an access gateway apparatus, a radio network controller (RNC), a mobility management entity (MME) and so on, but is by no means limited to these.

A plurality of user terminal 20A, 20B and 20C can communicate with the radio base station 10 in a cell 50. For example, the user terminal 20A is a user terminal that supports LTE (up to Rel-10) or LTE-Advanced (including Rel-10 and later versions) (hereinafter referred to as an “LTE terminal”), and the other user terminals 20B and 20C are MTC terminals that serve as communication devices in machine communication systems. Hereinafter the user terminals 20A, 20B and 20C will be simply referred to as “user terminals 20,” unless specified otherwise.

Note that the MTC terminals 20B and 20C are terminals that support various communication schemes including LTE and LTE-A, and are by no means limited to stationary communication terminals such electric meters, gas meters, vending machines and so on, and can be mobile communication terminals such as vehicles. Furthermore, the user terminals 20 may communicate with other user terminals directly, or communicate with other user terminals via the radio base station 10.

In the radio communication system 1, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency bandwidth into a plurality of reduced frequency bandwidths (subcarriers) and mapping data to each subcarrier. SC-FDMA is a single-carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are by no means limited to the combination of these.

In the radio communication system 1, a downlink shared channel (PDSCH: Physical Downlink Shared CHannel), which is used by each user terminal 20 on a shared basis, a broadcast channel (PBCH: Physical Broadcast CHannel), downlink L1/L2 control channels and so on are used as downlink channels. User data, higher layer control information and predetermined SIBs (System Information Blocks) are communicated in the PDSCH. Also, the MIB (Master Information Blocks) is communicated in the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI) including PDSCH and PUSCH scheduling information is communicated by the PDCCH. The number of OFDM symbols to use for the PDCCH is communicated by the PCFICH. HARQ delivery acknowledgement signals (ACKs/NACKs) in response to the PUSCH are communicated by the PHICH. The EPDCCH is frequency-division-multiplexed with the PDSCH and used to communicate DCI and so on, like the PDCCH.

In the radio communication system 1, an uplink shared channel (PUSCH: Physical Uplink Shared CHannel), which is used by each user terminal 20 on a shared basis, an uplink control channel (PUCCH: Physical Uplink Control CHannel), a random access channel (PRACH: Physical Random Access CHannel) and so on are used as uplink channels. User data and higher layer control information are communicated by the PUSCH. Also, downlink radio quality information (CQI: Channel Quality Indicator), delivery acknowledgement signals and so on are communicated by the PUCCH. By means of the PRACH, random access preambles for establishing connections with cells are communicated.

<Radio Base Station>

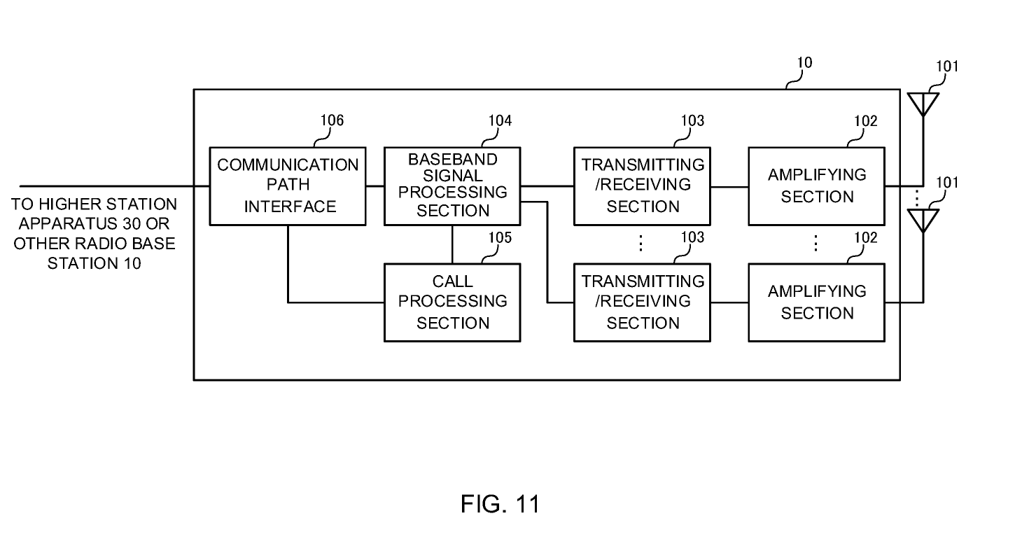

FIG. 11 is a diagram to show an example of an overall structure of a radio base station according to one embodiment of the present invention. A radio base station 10 has a plurality of transmitting/receiving antennas 101, amplifying sections 102, transmitting/receiving sections 103, a baseband signal processing section 104, a call processing section 105 and a communication path interface 106.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to a PDCP (Packet Data Convergence Protocol) layer process, user data division and coupling, RLC (Radio Link Control) layer transmission processes such as an RLC retransmission control transmission process, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Each transmitting/receiving section 103 converts baseband signals that are pre-coded and output from the baseband signal processing section 104 on a per antenna basis, into a radio frequency bandwidth. The transmitting/receiving sections 103 can be constituted by transmitters/receivers, transmitting/receiving circuits or transmitting/receiving devices that can be described based on common understanding of the technical field to which the present invention pertains. Note that a transmitting/receiving section 103 may be structured as a transmitting/receiving section in one entity, or may be constituted by a transmitting section and a receiving section.

The radio frequency signals having been subjected to frequency conversion in the transmitting/receiving sections 103 are amplified in the amplifying sections 102, and transmitted from the transmitting/receiving antennas 101. The transmitting/receiving sections 103 can transmit and/or receive various signals in a narrow bandwidth (for example, 1.4 MHz) that is more limited than a system bandwidth (for example, one component carrier).

The transmitting/receiving sections 103 transmit DCI that includes information related to repetition factors, to the user terminals 20. The transmitting/receiving sections 103 may transmit information related to the combinations of MCS levels and repetition levels, information related to the combinations of repetition levels and repetition factors, and so on.

Meanwhile, as for uplink signals, radio frequency signals that are received in the transmitting/receiving antennas 101 are each amplified in the amplifying sections 102. Each transmitting/receiving section 103 receives uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10 and manages the radio resources.

The communication path interface section 106 transmits and receives signals to and from the higher station apparatus 30 via a predetermined interface. Also, the communication path interface 106 may transmit and/or receive signals (backhaul signaling) with other radio base stations 10 via an inter-base station interface (for example, an interface in compliance with the CPRI (Common Public Radio Interface), such as optical fiber, the X2 interface, etc.).

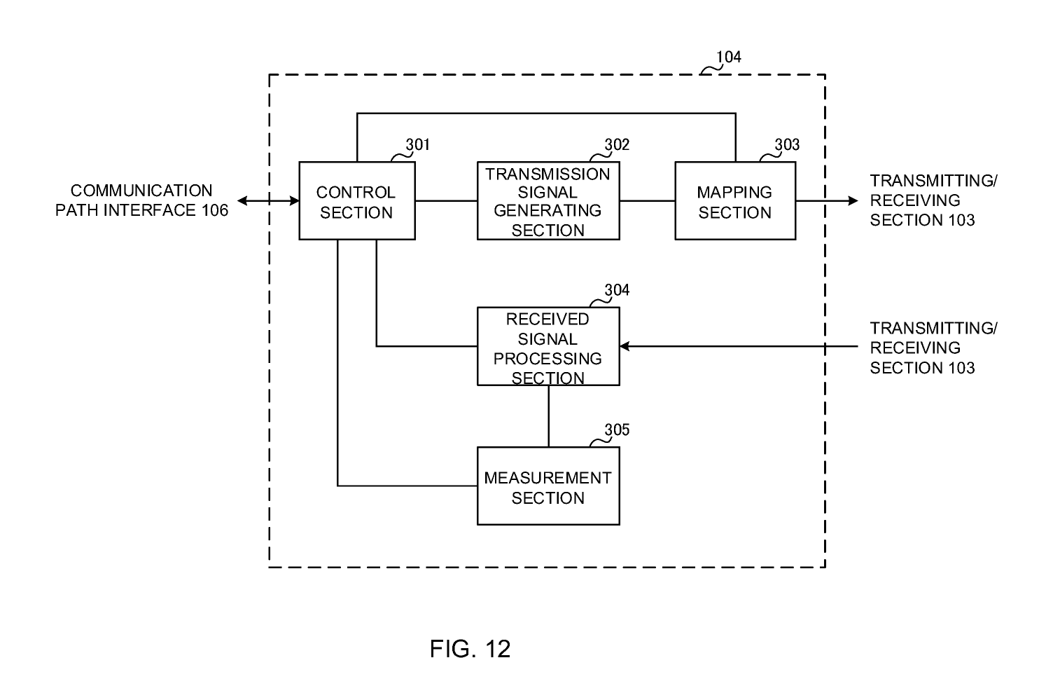

FIG. 12 is a diagram to show an example of a functional structure of a radio base station according to the present embodiment. Note that, although FIG. 12 primarily shows functional blocks that pertain to characteristic parts of the present embodiment, the radio base station 10 has other functional blocks that are necessary for radio communication as well. As shown in FIG. 12, the baseband signal processing section 104 has a control section (scheduler) 301, a transmission signal generating section (generation section) 302, a mapping section 303, a received signal processing section 304 and a measurement section 305.

The control section (scheduler) 301 controls the whole of the radio base station 10. The control section 301 can be constituted by a controller, a control circuit or a control device that can be described based on common understanding of the technical field to which the present invention pertains.

The control section 301, for example, controls the generation of signals in the transmission signal generating section 302, the allocation of signals by the mapping section 303, and so on. Furthermore, the control section 301 controls the signal receiving processes in the received signal processing section 304, the measurements of signals in the measurement section 305, and so on.

The control section 301 controls the scheduling (for example, resource allocation) of downlink data signals that are transmitted in the PDSCH and downlink control signals that are communicated in the PDCCH and/or the EPDCCH. Also, the control section 301 controls the scheduling of synchronization signals, and downlink reference signals such as CRSs (Cell-specific Reference Signals), CSI-RSs (Channel State Information Reference Signals), DM-RSs (Demodulation Reference Signals) and so on.

Also, the control section 301 controls the scheduling of uplink data signals transmitted in the PUSCH, uplink control signals transmitted in the PUCCH and/or the PUSCH (for example, delivery acknowledgement signals (HARQ-ACKs)), random access preambles transmitted in the PRACH, uplink reference signals and so on.

The control section 301 controls the transmission signal generating section 302 and the mapping section 303 to allocate various signals to narrow bandwidths and transmit these to the user terminals 20. For example, the control section 301 controls downlink broadcast information (the MIB, SIBs, etc.), EPDCCHs, PDSCHs and so on, to be transmitted in narrow bandwidths.

Also, the control section 301 controls (configures) the repetition factors to apply to a predetermined user terminals 20's transmission signal and/or received signal. Also, the control section 301 exerts control so that information related to the repetition factors is reported to the user terminal 20 in DCI. Here, the control section 301 selects the information related to the repetition factors in association with the MCSs applied to the signals.

The control section 301 reports the selected repetition factor-related information to the user terminal 20. To be more specific, the control section 301 may report the selected repetition factor-related information to the user terminal 20, implicitly, by reporting for example, MCS indices (first embodiment). In this case, the control section 301 may be configured to report information related to combinations (table) of MCS levels (for example, MCS indices) and repetition levels to the user terminal 20 by using broadcast information (the MIB, SIBs, etc.), higher layer signaling (for example, RRC signaling) and so on.

The control section 301 may have the combinations (table) for use in normal coverage mode and the combinations (table) for use in enhanced coverage mode, separately. Here, the table for normal coverage mode should preferably be designed so that, when the MCS index increases the repetition factor stays the same and/or becomes smaller (method 1 of the first embodiment). Also, the table for enhanced coverage mode should preferably be designed so that, when the MCS index (and/or the TBS index) increases, the repetition factor stays the same and/or becomes larger (method 2 of the first embodiment).

The control section 301 can select the above table taking the coverage into consideration, based on a measurement report from the user terminal. For example, the control section 301 can select the table for enhanced coverage mode from candidate tables (subsets). In this case, the control section 301 may report table selection information for selecting the table to use, to the user terminal 20.

The control section 301 may report information related to these tables (information related to the reconfiguration of the tables, information related to the subsets, etc.) to the user terminal 20.

Furthermore, the control section 301 can report selected repetition factor-related information to the user terminal 20, explicitly, by using part of the fields in DCI (second embodiment). The control section 301 may report information related to combinations (table) of repetition levels (indices) and the numbers of repetitions to report in DCI to the user terminal 20 by using, for example, broadcast information.

Furthermore, the control section 301 may report information to indicate whether to operate in normal coverage-supporting mode (normal coverage mode) or coverage enhancement-supporting mode (coverage enhancement mode), to the user terminal 20, by using, for example, broadcast information, higher layer signaling, downlink control information and so on.

The control section 301 outputs information related to the repetition factor, the MCS level and so on to apply to each user terminal 20, to the received signal processing section 304.

The transmission signal generating section (generation section) 302 generates downlink signals (downlink control signals, downlink data signals, downlink reference signals, etc.) based on commands from the control section 301 and outputs these signals to the mapping section 303. The transmission signal generating section 302 can be constituted by a signal generator, a signal generating circuit or a signal generating device that can be described based on common understanding of the technical field to which the present invention pertains.

For example, the transmission signal generating section 302 generates DL assignments, which report downlink signal allocation information, and UL grants, which report uplink signal allocation information, based on commands from the control section 301. Also, the downlink data signals are subjected to a coding process and a modulation process, based on coding rates and modulation schemes that are determined based on channel state information (CSI) from each user terminal 20 and so on.

Also, when repetitious transmission of a downlink signal (for example, repetitious transmission of the PDSCH) is configured, the transmission signal generating section 302 generates the same downlink signal over a plurality of subframes and outputs these signals to the mapping section 303.

Furthermore, based on commands from the control section 301, the transmission signal generating section 302 generates DCI, which includes information related to repetition factors, and outputs this to the mapping section 303.

The mapping section 303 maps the downlink signals generated in the transmission signal generating section 302 to predetermined narrow bandwidth radio resources (for example, maximum 6 resource blocks) based on commands from the control section 301, and outputs these to the transmitting/receiving sections 103. The mapping section 303 can be constituted by a mapper, a mapping circuit or a mapping device that can be described based on common understanding of the technical field to which the present invention pertains.

The received signal processing section 304 performs receiving processes (for example, demapping, demodulation, decoding and so on) of received signals that are input from the transmitting/receiving sections 103. Here, the received signals include, for example, uplink signals transmitted from the user terminals 20 (uplink control signals, uplink data signals, uplink reference signals, etc.). For the received signal processing section 304, a signal processor, a signal processing circuit or a signal processing device that can be described based on common understanding of the technical field to which the present invention pertains can be used.

The received signal processing section 304 applies receiving processes for repeated signals, to the signals received from the user terminals 20 that carry out repetitious signal transmission. The received signal processing section 304 outputs the decoded information acquired through the receiving processes to the control section 301. Also, the received signal processing section 304 outputs the received signals, the signals after the receiving processes and so on, to the measurement section 305.

The measurement section 305 conducts measurements with respect to the received signals. The measurement section 305 can be constituted by a measurer, a measurement circuit or a measurement device that can be described based on common understanding of the technical field to which the present invention pertains.

Also, by using the received signals, the received signal processing section 304 may measure the received power (for example, RSRP (Reference Signal Received Power)), the received quality (for example, RSRQ (Reference Signal Received Quality)), channel states and so on. The measurement results may be output to the control section 301.

<User Terminal>

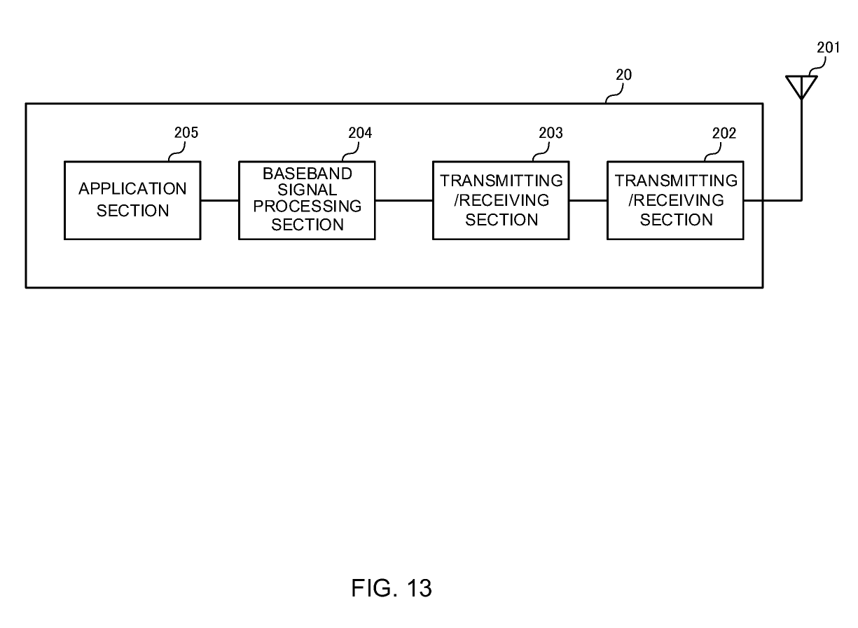

FIG. 13 is a diagram to show an example of an overall structure of a user terminal according to the present embodiment. Note that, although not described in detail herein, normal LTE terminals may operate to act as MTC terminals. A user terminal 20 has a transmitting/receiving antenna 201, an amplifying section 202, a transmitting/receiving section 203, a baseband signal processing section 204 and an application section 205. Also, the user terminal 20 may have a plurality of transmitting/receiving antennas 201, amplifying sections 202, transmitting/receiving sections 203 and/or others.

A radio frequency signal that is received in the transmitting/receiving antenna 201 is amplified in the amplifying section 202. The transmitting/receiving section 203 receives the downlink signal amplified in the amplifying section 202. For example, the transmitting/receiving section 203 receives DCI that includes information related to repetition factors.

The received signal is subjected to frequency conversion and converted into the baseband signal in the transmitting/receiving section 203, and output to the baseband signal processing section 204. The transmitting/receiving section 203 can be constituted by a transmitters/receiver, a transmitting/receiving circuit or a transmitting/receiving device that can be described based on common understanding of the technical field to which the present invention pertains. Note that the transmitting/receiving section 203 may be structured as a transmitting/receiving section in one entity, or may be constituted by a transmitting section and a receiving section.

In the baseband signal processing section 204, the baseband signal that is input is subjected to an FFT process, error correction decoding, a retransmission control receiving process, and so on. Downlink user data is forwarded to the application section 205. The application section 205 performs processes related to higher layers above the physical layer and the MAC layer, and so on. Furthermore, in the downlink data, broadcast information is also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, pre-coding, a discrete Fourier transform (DFT) process, an IFFT process and so on, and the result is forwarded to the transmitting/receiving section 203. The baseband signal that is output from the baseband signal processing section 204 is converted into a radio frequency bandwidth in the transmitting/receiving section 203. The radio frequency signal that is subjected to frequency conversion in the transmitting/receiving section 203 is amplified in the amplifying section 202, and transmitted from the transmitting/receiving antenna 201.

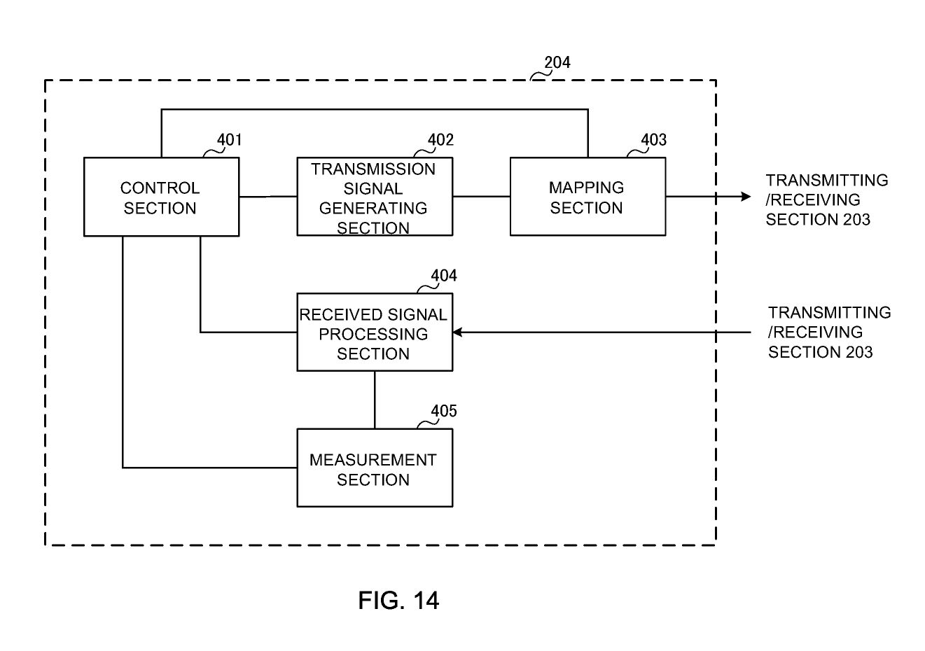

FIG. 14 is a diagram to show an example of a functional structure of a user terminal according to the present embodiment. Note that, although FIG. 14 primarily shows functional blocks that pertain to characteristic parts of the present embodiment, the user terminal 20 has other functional blocks that are necessary for radio communication as well. As shown in FIG. 14, the baseband signal processing section 204 provided in the user terminal 20 has a control section 401, a transmission signal generating section (generation section) 402, a mapping section 403, a received signal processing section 404 and a measurement section 405.

The control section 401 controls the whole of the user terminal 20. The control section 401 can be constituted by a controller, a control circuit or a control device that can be described based on common understanding of the technical field to which the present invention pertains.

The control section 401, for example, controls the generation of signals in the transmission signal generating section 402, the allocation of signals by the mapping section 403, and so on. Furthermore, the control section 401 controls the signal receiving processes in the received signal processing section 404, the measurements of signals in the measurement section 405, and so on.

The control section 401 acquires the downlink control signals (signals transmitted in the PDCCH/EPDCCH) and downlink data signals (signals transmitted in the PDSCH) transmitted from the radio base station 10, from the received signal processing section 404. The control section 401 controls the generation of uplink control signals (for example, delivery acknowledgement signals (HARQ-ACKs) and so on) and uplink data signals based on the downlink control signals, the results of deciding whether or not re transmission control is necessary for the downlink data signals, and so on.

Also, if the repetition factor for an uplink signal (for example, the PUCCH, the PUSCH, etc.) is configured in the user terminal 20, the control section 401 exerts control so that signals carrying the same information are transmitted in repetitions over a plurality of subframes, based on repetition factor-related information received from the radio base station 10.

When information to indicate whether to operate in normal coverage mode or in coverage enhancement mode is input from the received signal processing section 404, the control section 401 can judge its mode based on this information. Also, the control section 401 can judge this mode based on the repetition factor-related information.

The control section 401 judges the repetition factors to apply to the transmission/receipt of given (predetermined) signals based on information related to repetition factors included in DCI transmitted from the radio base station 10. Then, the control section 401 controls the transmission signal generating section 402 and the mapping section 403 by using the repetition factor pertaining to transmission signals, and controls the received signal processing section 404 and the measurement section 405 by using the repetition factor pertaining to received signals.

The control section 401 may reference combinations of MCS levels and repetition levels (table), so that, when an MCS index is input from the received signal processing section 404, the control section 401 can judge the repetition factor to match this MCS index (first embodiment). In this case, when the control section 401 may reference different tables depending on the mode of coverage. The control section 401 may select the table to use based on table reconfiguration information, table selection information and so on.

Also, the control section 401 may reference combinations of repetition levels and repetition factors (table), and judge the repetition factor to apply to a predetermined signal based on a predetermined field included in DCI that is input from the received signal processing section 404 (second embodiment).

Also, when a repetition factor is configured for a downlink signal, the control section 401 may output information related to the repetition factor to the received signal processing section 404 so that the receiving processes are performed based on this information.

The transmission signal generating section 402 generates uplink signals (uplink control signals, uplink data signals, uplink reference signals, etc.) based on commands from the control section 401, and outputs these signals to the mapping section 403. The transmission signal generating section 402 can be constituted by a signal generator, a signal generating circuit or a signal generating device that can be described based on common understanding of the technical field to which the present invention pertains.

For example, the transmission signal generating section 402 generates uplink control signals such as delivery acknowledgement signals (HARQ-ACKs), channel state information (CSI) and so on, based on commands from the control section 401. Also, the transmission signal generating section 402 generates uplink data signals based on commands from the control section 401. For example, when a UL grant is included in a downlink control signal that is reported from the radio base station 10, the control section 401 commands the transmission signal generating section 402 to generate an uplink data signal.

Also, when the user terminal 20 is configured to transmit a predetermined uplink signal in repetitions, the transmission signal generating section 402 generates the same uplink signal over a plurality of subframes, and outputs these signals to the mapping section 403. The number of repetitions may be increased and/or decreased based on commands from the control section 401.

The mapping section 403 maps the uplink signals generated in the transmission signal generating section 402 to radio resources (maximum 6 resource blocks) based on commands from the control section 401, and outputs these to the transmitting/receiving sections 203. The mapping section 403 can be constituted by a mapper, a mapping circuit or a mapping device that can be described based on common understanding of the technical field to which the present invention pertains.

The received signal processing section 404 performs receiving processes (for example, demapping, demodulation, decoding and so on) of received signals that are input from the transmitting/receiving sections 203. Here, the received signals include, for example, downlink signals (downlink control signals, downlink data signals, downlink reference signals and so on) that are transmitted from the radio base station 10. The received signal processing section 404 can be constituted by a signal processor, a signal processing circuit or a signal processing device that can be described based on common understanding of the technical field to which the present invention pertains.

The received signal processing section 404 applies receiving processes for repeated signals to signals received from the radio base stations 10 that carry out repetitious signal transmission. The received signal processing section 404 output the decoded information that is acquired through the receiving processes to the control section 401. The received signal processing section 404 outputs, for example, broadcast information, system information, RRC signaling, DCI and so on, to the control section 401. Also, the received signal processing section 404 outputs the received signals, the signals after the receiving processes and so on to the measurement section 405.

The measurement section 405 conducts measurements with respect to the received signals. The measurement section 405 can be constituted by a measurer, a measurement circuit or a measurement device that can be described based on common understanding of the technical field to which the present invention pertains.

The measurement section 405 may measure, for example, the received power (for example, RSRP), the received quality (for example, RSRQ), the channel states and so on of the received signals. The measurement results may be output to the control section 401.

Note that the block diagrams that have been used to describe the above embodiments show blocks in functional units. These functional blocks (components) may be implemented in arbitrary combinations of hardware and software. Also, the means for implementing each functional block is not particularly limited. That is, each functional block may be implemented with one physically-integrated device, or may be implemented by connecting two physically-separate devices via radio or wire and using these multiple devices.

For example, part or all of the functions of the radio base station 10 and the user terminal 20 may be implemented by using hardware such as an ASIC (Application-Specific Integrated Circuit), a PLD (Programmable Logic Device), an FPGA (Field Programmable Gate Array) and so on. Also, the radio base stations 10 and user terminals 20 may be implemented with a computer device that includes a processor (CPU), a communication interface for connecting with networks, a memory and a computer-readable storage medium that holds programs. That is, the radio base stations and user terminals according to an embodiment of the present invention may function as computers that execute the processes of the radio communication method of the present invention.

Here, the processor and the memory are connected with a bus for communicating information. Also, the computer-readable recording medium is a storage medium such as, for example, a flexible disk, an opto-magnetic disk, a ROM (Read Only Memory), an EPROM (Erasable Programmable ROM), a CD-ROM (Compact Disc-ROM), a RAM (Random Access Memory), a hard disk and so on. Also, the programs may be transmitted from the network through, for example, electric communication channels. Also, the radio base stations 10 and user terminals 20 may include input devices such as input keys and output devices such as displays.

The functional structures of the radio base stations 10 and user terminals 20 may be implemented with the above-described hardware, may be implemented with software modules that are executed on the processor, or may be implemented with combinations of both. The processor controls the whole of the user terminals by running an operating system. Also, the processor reads programs, software modules and data from the storage medium into the memory, and executes various types of processes.

Here, these programs have only to be programs that make a computer execute each operation that has been described with the above embodiments. For example, the control section 401 of the user terminals 20 may be stored in the memory and implemented by a control program that operates on the processor, and other functional blocks may be implemented likewise.

Now, although the present invention has been described in detail above, it should be obvious to a person skilled in the art that the present invention is by no means limited to the embodiments described herein. For example, the above-described embodiments may be used individually or in combinations. The present invention can be implemented with various corrections and in various modifications, without departing from the spirit and scope of the present invention defined by the recitations of claims. Consequently, the description herein is provided only for the purpose of explaining example s, and should by no means be construed to limit the present invention in any way.

The disclosure of Japanese Patent Application No. 2015-080322, filed on Apr. 9, 2015, including the specification, drawings and abstract, is incorporated herein by reference in its entirety.

1. A user terminal, in which a bandwidth to use is limited to a partial narrow bandwidth in a system bandwidth, the user terminal comprising:
a receiving section that receives downlink control information (DCI), which includes information related to a repetition factor; and
a control section that judges a repetition factor to apply to transmission and/or receipt of a predetermined signal based on the information related to the repetition factor,
wherein the information related to the repetition factor is selected in association with an MCS (Modulation and Coding Scheme) that is applied to the predetermined signal.

2. The user terminal according to claim 1, wherein the information related to the repetition factor is an MCS index.

3. The user terminal according to claim 2, wherein, in normal coverage mode, the control section judges the repetition factor based on a first table that is designed so that the repetition factor stays the same or becomes smaller when the MCS index increases.

4. The user terminal according to claim 2, wherein the control section judges the repetition factor based on a second table that is designed so that the repetition factor stays the same or becomes larger when the MCS index increases.

5. The user terminal according to claim 4, wherein the second table is further designed so that the repetition factor stays the same or becomes larger when a TBS (Transport Block Size) index increases.

6. The user terminal according to claim 4, wherein:
the receiving section receives table selection information for selecting the second table from a plurality of candidates; and
the control section selects the second table based on the table selection information.

7. The user terminal according to claim 1, wherein:
the information related to the repetition factor is an index that is represented by using part or all of a predetermined field that is provided in DCI in an existing system; and
the receiving section further receives information related to a combination of the index and the repetition factor.

8. The user terminal according to claim 7, wherein the predetermined field is one of a resource allocation field, an MCS field and an HPN (HARQ Process Number) field.

9. A radio base station that communicates with a user terminal, in which a bandwidth to use is limited to a partial narrow bandwidth in a system bandwidth, the radio base station comprising:
a control section that controls a repetition factor to apply to transmission and/or receipt of a predetermined signal;
a generation section that receives downlink control information (DCI), which includes information related to the repetition factor; and
a transmission section that transmits the DCI to the user terminal,
wherein the generation section generates the information related to the repetition factor in association with an MCS (Modulation and Coding Scheme) that is applied to the predetermined signal.

10. A radio communication method to allow a user terminal, in which a bandwidth to use is limited to a partial narrow bandwidth in a system bandwidth, and a radio base station to communicate, the radio communication method comprising, in the user terminal, the steps of:
receiving downlink control information (DCI), which includes information related to a repetition factor; and
judging a repetition factor to apply to transmission and/or receipt of a predetermined signal based on the information related to the repetition factor,
wherein the information related to the repetition factor is selected in association with an MCS (Modulation and Coding Scheme) that is applied to the predetermined signal.
